(19) United States
(12) Patent Application Publication
(10) Pub. No.: US 2025/0200357 A1
(43) Pub. Date: Jun. 19, 2025

(54) ENTERPRISE ENGAGEMENT USING MACHINE LEARNING IN DIGITAL WORKPLACE

(71) Applicant: SAP SE, Walldorf (DE)

(72) Inventors: Gopi Kishan, Bangalore (IN); Rohit Jalagadugula, Visakhapatnam (IN); Kavitha Krishnan, Bangalore (IN); Movish Verma, Mandi Gobindgarh (IN); Priyanka Meena, Baran (IN); Akash Srivastava, Lucknow (IN); Prateek Garg, Vadodara (IN); Maheswar Reddy Pulla, Ananthapur (IN); Manoj Kumar, Panchkula (IN)

(21) Appl. No.: 18/543,047

(22) Filed: Dec. 18, 2023

(51) Int. Cl. G06N 3/08

(52) U.S. Cl. CPC G06N 3/08

(57) ABSTRACT

Methods, systems, and computer-readable storage media for receiving a communication, aggregating user data and event data, the user data representative of a user that as an addressee of the communication, the event data representative of an event described in the communication, determining, from a GNN, a sub-GNN that is specific to the user, the GNN including a data structure that represents users of an enterprise and relationships between users, the sub-GNN representing a portion of the GNN, providing an updated sub-GNN based on the event data, generating a recommendation regarding the event using the updated sub-GNN, the recommendation being specific to the user, providing reason text from a LLM responsive to a prompt, and transmitting a notification to the user, the notification including the recommendation and the reason text.

### BACKGROUND

Employment patterns are evolving in the current epoch of the knowledge economy and digital working environment. As the millennial generation becomes the major workforce, the rise of new trends, interests, skill sets, and the like, employee engagement in the workplace can become increasingly challenging. Enterprises use analytics-based tools for tracking engagement and participation in activities, which tools depend on data collected from employee surveys and other feedback channels. Such analytics are usually static and retrospective, and cannot reflect the current employee engagement status, much less predict future trends, or determine which activities are interesting and/or beneficial for individual employees. Consequently, it is difficult for enterprises to take proactive or preventive actions in a fast-paced working environment that often includes a rapidly changing team.

### SUMMARY

Implementations of the present disclosure are directed to a recommendation system for resource-efficient generation of recommendations to users. More particularly, implementations of the present disclosure are directed to a recommendation system that generates recommendations to users using a graph neural network (GNN) and a large language model (LLM) for resource-efficient identification of events relevant to users and generating explanations on relevance of events recommended to users.

In some implementations, actions include receiving a communication, aggregating user data and event data, the user data representative of a user that as an addressee of the communication, the event data representative of an event described in the communication, determining, from a GNN, a sub-GNN that is specific to the user, the GNN including a data structure that represents users of an enterprise and relationships between users, the sub-GNN representing a portion of the GNN, providing an updated sub-GNN based on the event data, generating a recommendation regarding the event using the updated sub-GNN, the recommendation being specific to the user, providing reason text from a LLM responsive to a prompt, and transmitting a notification to the user, the notification including the recommendation and the reason text. Other implementations of this aspect include corresponding systems, apparatus, and computer programs, configured to perform the actions of the methods, encoded on computer storage devices.

These and other implementations can each optionally include one or more of the following features: providing an updated sub-GNN based on the event data includes updating weight matrices of edges of the sub-GNN based on the event data; updating includes each node of the sub-GNN executing computation and aggregation to update a respective weight matrix; the prompt is generated using a prompt template; actions further include receiving feedback from the user regarding the event, at least a portion of the feedback being stored as an attribute in a node of the GNN, the node representing the user; the sub-GNN is a k-hop representation from a node of the user within the GNN; and aggregating user data and event data is executed in response to determining that the communication describes the event.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example recommendation system in accordance with implementations of the present disclosure.

FIG. 3 depicts an example portion of an employee network graph in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to a recommendation system for resource-efficient generation of recommendations to users. More particularly, implementations of the present disclosure are directed to a recommendation system that generates recommendations to users using a graph neural network (GNN) and a large language model (LLM) for resource-efficient identification of events relevant to users and generating explanations on relevance of events recommended to users.

Implementations can include actions of receiving a communication, aggregating user data and event data, the user data representative of a user that as an addressee of the communication, the event data representative of an event described in the communication, determining, from a GNN, a sub-GNN that is specific to the user, the GNN including a data structure that represents users of an enterprise and relationships between users, the sub-GNN representing a portion of the GNN, providing an updated sub-GNN based on the event data, generating a recommendation regarding the event using the updated sub-GNN, the recommendation being specific to the user, providing reason text from a LLM responsive to a prompt, and transmitting a notification to the user, the notification including the recommendation and the reason text.

To provide further context for implementations of the present disclosure, and as introduced above, employment patterns are evolving in the current epoch of the knowledge economy and digital working environment. As the millennial generation becomes the major workforce, the rise of new trends, interests, skill sets, and the like, employee engagement in the workplace can become increasingly challenging. Enterprises use analytics-based tools for tracking engagement and participation in activities, which tools depend on data collected from employee surveys and other feedback channels. Such analytics are usually static and retrospective, and cannot reflect the current employee engagement status, much less predict future trends, or determine which activities are interesting and/or beneficial for individual employees. Consequently, it is difficult for enterprises to take proactive or preventive actions in a fast-paced working environment that often includes a rapidly changing team.

For example, an enterprise can be described as a bustling hive of work-related tasks, as well as activities and events. Example activities and events can include team building, education, skill building/improvement, and the like. Employees are overwhelmed with the myriad of options, and recognizing which options are genuinely beneficial is becoming increasingly difficult. This situation often leads to missed opportunities and inefficiencies in time management. In some cases, a recommendation system can be implemented to make recommendations to employees. However, traditional recommendation systems are inefficient in terms of resources expended for data processing and recommendation generation. That is, to generate recommendations, technical resources (e.g., processing, memory, network bandwidth) are expended. Traditional recommendation systems have other deficiencies. For example, although recommendations are made, an explanation as to why a particular recommendation is either lacking or does not provide an effective recommendation (e.g., description of the reasoning behind the recommendation, recommendations not personalized to specific users).

In view of the above context, implementations of the present disclosure provide a recommendation system that provides user-specific recommendations for events within context of an enterprise. More particularly, and as described in further detail herein, the recommendation system of the present disclosure generates recommendations to users using a GNN and a LLM for resource-efficient identification of events relevant to users and generating explanations on relevance of events recommended to users.

While the recommendation system of the present disclosure is described in further detail herein with reference to recommendations to users that are employees in an enterprise context, it is contemplated that implementations of the present disclosure can be realized for recommendations in any appropriate context.

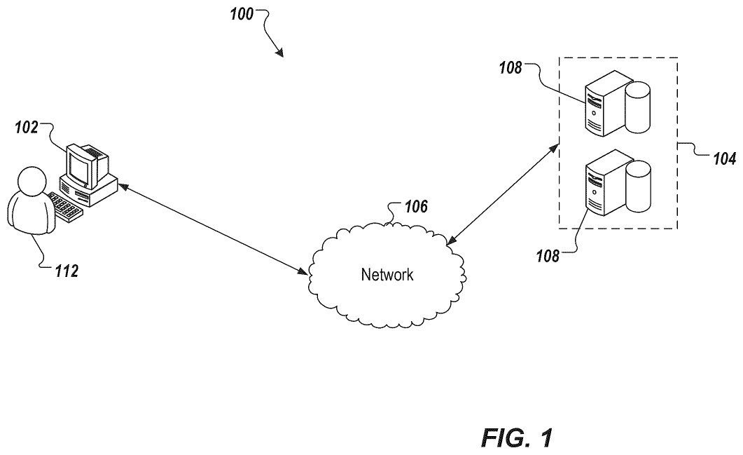

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a recommendation system for generates recommendations to users using a GNN and a LLM for resource-efficient identification of events relevant to users and generating explanations on relevance of events recommended to users.

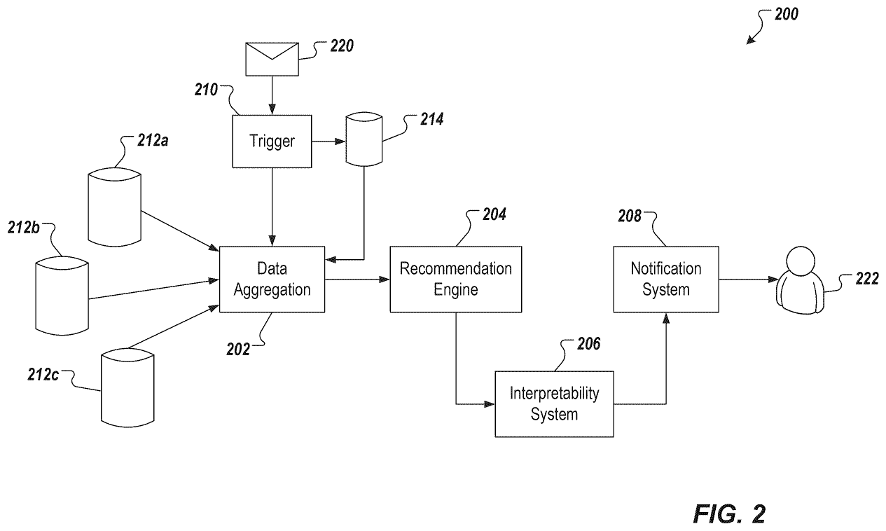

FIG. 2 depicts an example recommendation system 200 in accordance with implementations of the present disclosure. In the depicted example, the recommendation system 200 includes a data aggregation module 202, a recommendation engine 204, an interpretability system 206, a notification system 208, a trigger module 210, a set of data sources 212a, 212b, 212c, and an event data store 214. As described in further detail herein, in response to a communication 220 that is sent to a user 222, the recommendation system 200 can selectively make a recommendation to the user. For example, if the communication 220 is descriptive of an event, the recommendation system 200 can generate a recommendation to the user 222 as to whether the user should attend the event. In the context of implementations of the present disclosure, the user 222 can be an employee of an enterprise, for which the recommendation system 200 is provided.

In further detail, each communication that is sent to users of the enterprise is also provided to the recommendation system 200. For example, the communication 220 is sent to the user 222 (e.g., an email received by the user 222 in an email inbox) and is also provided to the recommendation system 200. In some examples, the communication 220 is associated with a set of users that received the communication 220. In some examples, the set of users includes a single user (e.g., the user 222). In some examples, the set of users includes multiple users (e.g., a group of users that includes the user 222). In some examples, each user can be associated with a unique identifier (e.g., an email address, an identification number (ID)).

In some examples, the trigger module 210 processes the communication 220 and selectively triggers generation of a recommendation to the user 222. For example, the trigger module 210 determines whether the communication 220 is representative of an event that is to occur at some point in the future. If the communication 220 is representative of such an event, the trigger module 210 initiates generation of a recommendation to the user 222. In some examples, the trigger module 210 determines whether the communication 220 is representative of an event by inputting the communication 220 to a machine learning (ML) model that classifies the communication 220 into a class in a set of classes (e.g., event class, non-event class). For example, the ML model is trained to predict the class using training data that includes communications representative of events and communications not representative events. In some examples, the trigger module 210 determines whether the communication 220 is representative of an event using natural language processing (NLP) to identify keywords and/or phrases descriptive of an event. If the communication 220 includes certain keywords and/or phrases descriptive of an event, the communication 220 is determined to be representative of an event.

In some examples, the event data store 214 stores event data representative of events that are scheduled to occur. For example, if the communication 220 is representative of an event, the trigger module 210 can extract event data that is descriptive of the event and store the event data in the event data store 214. Example event data can include, but is not limited to, date, time, space (location), title, description, sponsor(s), and speaker(s). In some examples, additional event data can be determined. For example, space represents a location of the event, which can include, without limitation, online and in-person. In some examples, the event data further includes space data that is descriptive of the space of the event. For example, for online events, example space data can include data representative of the particular online channel that the event is to occur through. As another example, for offline events, example space data can include data representative of the location (e.g., address, surrounding environment), and venue (e.g., capacity, sponsors, facilities).

In response to the communication 220 being representative of an event, the trigger module 210 sends a recommendation request to the data aggregation module 202. In some examples, the recommendation request includes a set of user identifiers and an event identifier. In some examples, the recommendation request includes the communication 220. The set of user identifiers can include one or more user identifiers, each uniquely identifying a user, to which the communication 220 was sent. As described in further detail herein, the data aggregation module 202 retrieves event data for the event (e.g., by querying the event data store 214 using the event identifier) and user data for each user (e.g., each user represented in the set of user identifiers).

In further detail, the data aggregation module 202 queries one or more of the data sources 212a, 212b, 212c to retrieve user data representative of a user, for which a recommendation is to be generated. Example data sources 212a, 212b, 212c can include application interaction data and human capital management (HCM) data. In some examples, the user data is retrieved through one or more application programming interface (API) calls. In some examples, application interaction data can include data representative of user interactions with one or more applications (e.g., to perform work-related tasks). For purposes of non-limiting illustration, example applications can include an email application, a chat application, a word processing application, a spreadsheet application, a source code development application, a web browser, and the like. In some examples, the applications are included in a suite of applications (e.g., Microsoft 365). In some examples, the HCM data can include a user profile (e.g., role, experience, education, location, department, skills, interests) and an organization chart. The HCM data can be provided from an HCM system (e.g., SAP Success Factors). The data aggregation module 202 provides the user data to the recommendation engine 204.

In some implementations, a network graph of users is provided, where each user is represented as a node in the network graph, each node being associated with a set of attributes representative of the user. Here, the network graph is provided as a GNN and each node can be defined as a data structure. An example node data structure is provided in Listing 1:

```
Node {
  node_id;
  hcm_attributes [ ];
  history: [{email content, space content, feedback}];
  network_node [node_id];
}
```

### Listing 1: Example Node Data Structure

In the example of Listing 1, node_id is a unique identifier of the node within the network graph, hcm_attributes [ ] is an array of attributes provided from HCM data, history is a list of interactions of the user and the recommendation system 200 (e.g., previous recommendation to the user and feedback for recommendations, if any), and network_node [ ] is an array of node identifier of all the nodes connected to the node. In some examples, network_node [ ] represents a sub-graph for the user (represented by node_id) within the network graph. In some examples, for new users (e.g., a recently hired employee), the sub-graph can be limited (e.g., only based on organization chart).

In general, the GNN is provided through a training phase, during which weight matrices between nodes are determined. In some examples, training is executed using data from multiple data sources, such as the data sources 212a, 212b, 212c of FIG. 2. In some examples, training includes computation, aggregation, self-node updating, and edge updating. In some examples, computation and aggregation are executed in both training and inference (prediction). In some examples, self-node updating and edge updating are executed in training. In some examples, computation includes self-attention, which includes dot product of features and weight matrix. In some examples, aggregation receives output of the computation from neighbor nodes and performs edge adjustment (e.g., attributes with neighbor (edge weight matrix)). This edge adjustment is for the fact that a node may have variable influence for different adjacent nodes.

As discussed herein, the network graph contains user information, as described above, while the GNN represents node information as node feature vectors and includes weight parameters learned during training. In some examples, both the network graph and the GNN have the same graph structure. That is, for example, the GNN is the same as the network graph with additional representation of node features (feature vectors) and learnable weight parameters.

In accordance with implementations of the present disclosure, the recommendation engine 204 processes the user data and the event data to generate a recommendation for the user. In some examples, the recommendation is a recommendation whether the user should attend the event. More particularly, the recommendation engine 204 provides a sub-GNN using the event data and the node of the user. The sub-GNN is used to provide a recommendation regarding the event to the user. In some examples, the sub-GNN is also used to provide a recommendation to one or more other users.

In some implementations, the sub-GNN is determined for the user, for which a recommendation is to be made. In some examples, the sub-GNN is provided as a k-hop (e.g., k=1) graph from the node that is representative of the user. In this manner, the sub-GNN is specific to the user and is representative of users that the user most closely interacts with within the enterprise. Here, the sub-GNN includes nodes of the users, each node being associated with attributes, and edges between nodes, each edge indicating a relationship between users represented by the nodes. In some examples, each edge is associated with a weight matrix that represents relative strength of relationship between users.

In accordance with implementations of the present disclosure, the sub-GNN is updated based on event data of the event described in the communication 220. In some examples, message passing through the sub-GNN is used to update the weight matrices between nodes. This is a multi-step process that includes computation and aggregation. More particularly, for each node in the sub-GNN of the network graph, a computation is executed using self-attention to determine a dot product between a feature vector and a node weight matrix, and aggregation is performed, in which the node receives output from each k-hop neighbor (e.g., k=1) and a dot product is determined using edge weights. In some examples, the communication 220 is represented as a feature vector using an embedder (e.g., a ML model that receives event data as input and provides a feature vector as output). The feature vector can be described as an n-dimensional representation of the event. The feature vector is provided to each k-hop neighbor and all nodes perform the multi-step process. The user node, for the user that the recommendation is being generated for, receives the feature vector and a score.

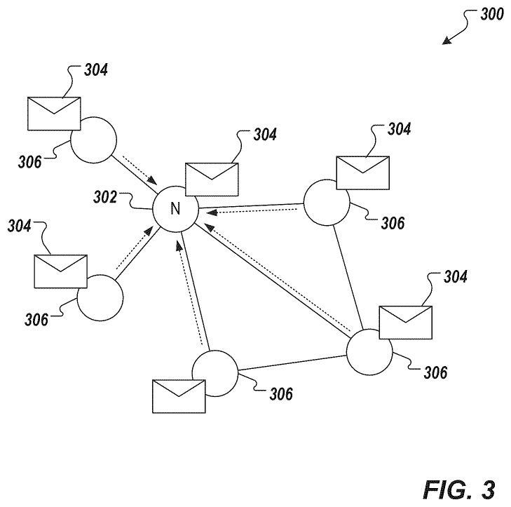

FIG. 3 depicts an example portion 300 of an employee network graph (sub-GNN) in accordance with implementations of the present disclosure. In the example of FIG. 3, the portion 300 includes a node N 302 that is representative of a user, for which a recommendation is to be generated, and a feature vector 304 that represents the communication (e.g., the communication 220 of FIG. 2) that triggered recommendation generation. In the example of FIG. 3, each k-hop neighbor (e.g., k=1) is represented as a node 306 and edges represent relationships between nodes. As discussed above, each node 306 executes the multi-step process and provides a feature vector and score to the node N 302.

In some implementations, for training of the GNN and subsequent use for inference, attributes of each node are represented as feature vectors. For example, and with non-limiting reference to Listing 1, hcm_attributes [ ] of each node is converted to a feature vector (e.g., hcm_attributes=[position, board area, business level, department, personnel area, region, sub region, location, timezone, . . . ]). In some examples, the feature vector is generated using one-hot encoding of the attributes. For example, there can be a attributes and each attribute can have t options. As such, for each node, a vector of dimension a×t is provided. By way of non-limiting example, for an employee, the following example attributes can be provided: hcm_attribute=[Data Scientist, Technology & Innovation, New Ventures & Technologies, ICN Bangalore, Bangalore
Campus, APJ, APJ, Bangalore, Asia/Kolkata . . . ]. For each attribute, the number of possible options (e.g., t) is known, for example, 5 (t=5). As an example, using one-hot encoding, the attribute of Data Scientist can be encoded as [0, 1, 0, 0, 0], where 1 denotes the positional encoding of Data Scientist in all possible options. As another example, using one-hot encoding, the attribute of Technology & Innovation can be encoded as [0, 0, 1, 0, 0], where 1 denotes the positional encoding of Technology & Innovation in all possible options. One-hot encoding is done for each attribute and the encodings are concatenated to provide the feature vector. Using the example one-hot encodings above, an example feature vector can be provided as [0, 1, 0, 0, 0, 0, 0, 1, 0, 0, . . . ]. Continuing with the employee example, the feature vector for employee i (and node i that represents the employee) can be denoted as Xᵢ.

For training, a portion of the history data (e.g., history: [{email content, space content, . . . }]) is converted to an appropriate format. For example, email content and space content can be provided as text data. In some examples, the text is concatenated and the concatenation is processed through a pre-trained language embedding model, which outputs a vector embedding. The vector embedding can be denoted as K. In some examples, another portion of the history data (e.g., feedback) can be converted to an appropriate format. For example, feedback can include whether the employee attended a session. Here, the feedback can be represented as a binary, where 1 indicates attendance and 0 indicates non-attendance (or vice-versa).

In accordance with implementations of the present disclosure, message passing is used, which enables nodes to aggregate information from neighboring nodes with information weightage on email and space content (the embedding K). Here, a GNN having L layers can be considered. Message passing can include initialization, message aggregation, rule updating, and iterating. In some examples, initialization includes inputting node features (Hᵢ^{(o)}=P×Xᵢ+Q×Kᵢ), for all nodes i in network, where H is a hidden state, Hᵢ and Xᵢ have the same dimension, and P and Q are learning weights. In message aggregation, for each node i at layer l, aggregated messages from neighbors can be computed as:

$${Msg}_{i}^{l} = {\sum }_{j ∈ neighbors ( i )} {Aggregation}^{( l )} ( {H}_{j}^{( l - 1 )} , {H}_{i}^{( l - 1 )} )$$

Here, Aggregation^{(l)} is a function that aggregates information from neighbors and l denotes the layer. In some examples, graph convolution is used for aggregation. For example:

$${Aggregation}^{( l )} ( {H}_{j}^{( l - 1 )} , {H}_{i}^{( l - 1 )} ) = {W}^{( l )} {H}_{j}^{( l - 1 )}$$

where W^{(l)} is a learnable weight matrix. In rule updating, the node representation is updated using the aggregated messages. For example:

$${H}_{i}^{l} = {Update}^{( l )} ( {H}_{i}^{( l - 1 )} , {Msg}_{i}^{( l )} )$$

The update function Update^{(l)} combines the current node representation with the aggregated messages. In some examples, a sigmoid function is used for updating. For example:

$${Update}^{( l )} ( {H}_{i}^{( l - 1 )} , {Msg}_{i}^{( l )} ) = σ ( {W}^{( l )} \cdot [ {H}_{i}^{( l - 1 )} , {Msg}_{i}^{( l )} ] ) ⊙ {H}_{i}^{( l - 1 )} + ( 1 - σ ( {W}^{( l )} \cdot [ {H}_{i}^{( l - 1 )} , {Msg}_{i}^{( l )} ] ) ) ⊙ {Msg}_{i}^{( l )}$$

where σ is the sigmoid function and W^{(l)}·[Hᵢ^{(l-1)}, Msgᵢ^{(l)}] computes a linear transformation of the concatenation of the previous node representation and the aggregated messages.

Iterations are executed to repeat the message aggregation and rule updating for each layer l of the L layers. For example:

$${H}_{i}^{l + 1} = {Update}^{( l + 1 )} ( {H}_{i}^{( l )} , {\sum }_{j ∈ neighbors ( i )} {Aggregation}^{( l )} ( {H}_{j}^{l} , {H}_{i}^{l} ) )$$

After iterating through all layers, the hidden state Hᵢ^{(l+1)} Hᵢ^{(l+1)} is passed through a fully connected network with sigmoid binary output and loss is computed using a true value Yᵢ from feedback. During training, gradients are backpropagated and weights P, Q, and W are learning.

In accordance with implementations of the present disclosure, the recommendation engine provides a recommendation as to whether the user should attend the event. For example, the sub-GNN can be queried as to whether the user (e.g., represented by the node N 302 of FIG. 3) should attend the event, and the sub-GNN can provide a prediction. In some examples, the prediction includes an indication of whether the user should attend the event. For example, the prediction can include attend or not attend. As another example, the prediction can include a score that can be compared to a threshold score to determine the recommendation (e.g., if score exceeds the threshold score, the user is recommended to the user. For example, a score between [0, 1] can provided and represents whether the event should be attended by the user (e.g., 0 indicating not attend, 1 indicating should attend).

In some implementations, the recommendation engine 204 sends a prompt to the interpretability system 206, which generates reason text that provides a reason for the recommendation. In some examples, the interpretability system 206 executes or otherwise accesses a LLM (e.g., ChatGPT accessed through API), which receives the prompt and generates the reason text. In some examples, the prompt is generated using a prompt template. The prompt can be described as a few-shot prompt that is input to the interpretability system 206 (the LLM), which processes the prompt to. Here, providing context in a few-shot prompt can be referred to as few-shot learning. In NLP, few-shot learning (also referred to as in-context learning and/or few-shot prompting) is a prompting technique that enables a LLM to process examples before attempting a task. Here, the task is generating reason text that is specific to the user and the examples can be reason text that had previously been generated.

In some implementations, the prompt can be provided using a prompt template. An example prompt template can be provided as:
Generate a compelling explanation for the employee, [Employee_Name], highlighting why they should join the upcoming session titled “[Session Title]”. Incorporate the [User_node_features] identified from their user node. Utilize content from the email [Email content] and session details [session content] to make it engaging and relevant for interests and professional growth by also grounding on [Top_node_features].
   Here, [ ] indicating placeholders that can be populated for the particular user and from other content. In some examples, user node features (User_node_features) are provided from the particular node of the user within the sub-GNN, and the top node features (Top_node_features) are provided from a feature map to determine significant features based on the hidden state Hᵢ^{(l+1)}.

In accordance with implementations of the present disclosure, the recommendation (with reason text) is provided to the notification system 208, which notifies the user 222 through one or more channels. Example channels can include, without limitation, email, chat, text, and the like. In some examples, a notification is sent to the user 222, which includes the recommendation (e.g., attend, do not attend) and the reason text, which describes the reason for the recommendation. In some examples, the channel can include a chatbot for recommending events as well as for collecting feedback from users, described in further detail herein. In some examples, the chatbot can be part of an employee communication application (e.g., MS Teams). As a result, recommendations can become a daily activity for the user. Here, push notifications will let the user know about an event, so likelihood of attending an event increases.

In some implementations, users can provide feedback regarding events, which feedback can be used to re-train the GNN, for example. In some examples, user feedback for an event is recorded in the history attribute of the nodes. Example user feedback can include whether the user attends the event, a quality of the event (e.g., subjective feedback of the user rating the event), and the like. In some examples, if the user is notified of the event (e.g., by a chatbot), the user can indicate an intent of whether attending the event. For example, the notification can include user interface (UI) elements to, for example, accept or decline the event, which selection is provided as feedback. In some examples, in response to accepting, the event can be added to a schedule of the user.

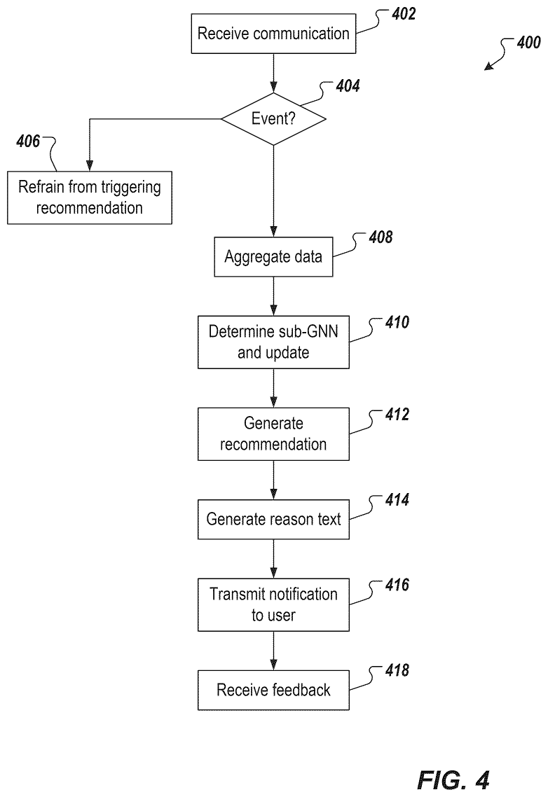

FIG. 4 depicts an example process 400 that can be executed in accordance with implementations of the present disclosure. In some examples, the example process 400 is provided using one or more computer-executable programs executed by one or more computing devices.

A communication is received (402). For example, and as described in further detail herein, each communication that is sent to users of the enterprise is also provided to the recommendation system 200. It is determined whether the communication represents an event (404). For example, and as described in further detail herein, the trigger module 210 processes the communication 220 and selectively triggers generation of a recommendation to the user 222. For example, the trigger module 210 determines whether the communication 220 is representative of an event that is to occur at some point in the future. If the communication does not represent an event, a recommendation is not generated (406).

If the communication does represent an event, data is aggregated (408). For example, and as described in further detail herein, the trigger module 210 sends a recommendation request to the data aggregation module 202. In some examples, the data aggregation module 202 retrieves event data for the event (e.g., by querying the event data store 214 using an event identifier) and user data for each user (e.g., each user represented in a set of user identifiers).

A sub-GNN is determined and is updated (410). For example, and as described in further detail herein, a (pre-trained) GNN is provided by the recommendation engine 204, the GNN being a graph data structure representing users within an enterprise and relationships between users. A node (e.g., the node N 302 of FIG. 3) is selected within the GNN as the node that represents the user, for which a recommendation is to be generated, and a sub-GNN is determined. As described herein, the sub-GNN includes the node and k-hop neighbor nodes to the node. Weight matrices of the sub-GNN are updated based on the event data for the event represented in the communication 220 through a computation and aggregation process, as described herein.

A recommendation is generated (412). For example, and as described in further detail herein, the recommendation engine 204 uses the (updated) sub-GNN to generate a recommendation. In some examples, the recommendation is provided as a score. Reason text is generated (414). For example, and as described in further detail herein, the recommendation engine 204 sends a prompt to the interpretability system 206, which generates reason text that provides a reason for the recommendation. In some examples, the interpretability system 206 executes or otherwise accesses a LLM (e.g., ChatGPT accessed through API), which receives the prompt and generates the reason text. In some examples, the reason text is a natural language description of why the particular recommendation has been made.

A notification is transmitted to the user (416). For example, and as described in further detail herein, the recommendation (with reason text) is provided to the notification system 208, which notifies the user 222 through one or more channels. For example, the channel can include a chatbot for recommending events as well as for collecting feedback from users. Feedback is received (418). For example, and as described in further detail herein, users can provide feedback regarding events, which feedback can be used to re-train the GNN, for example. In some examples, user feedback for an event is recorded in the history attribute of the nodes. Example user feedback can include whether the user attends the event, a quality of the event (e.g., subjective feedback of the user rating the event), and the like.

As described herein, implementations of the present disclosure achieve multiple technical improvements. For example, implementations of the present disclosure enable time- and resource-efficient modeling of complex relationships through use of a graph structure. In this manner, implementations of the present disclosure overcome deficiencies of traditional approaches that use, for example, explicit feature engineering, which is time- and resource-intensive and, hence, does not scale efficiently. Further, by grounding the information on email and space content, personalized and optimal recommendations can be provided to users. Implementations of the present disclosure, also resource-efficiently resolve the cold start problem of traditional recommendation systems using information extraction, as described in detail herein. Implementations of the present disclosure also maintain explainability through the LLM using hidden state feature mappings.

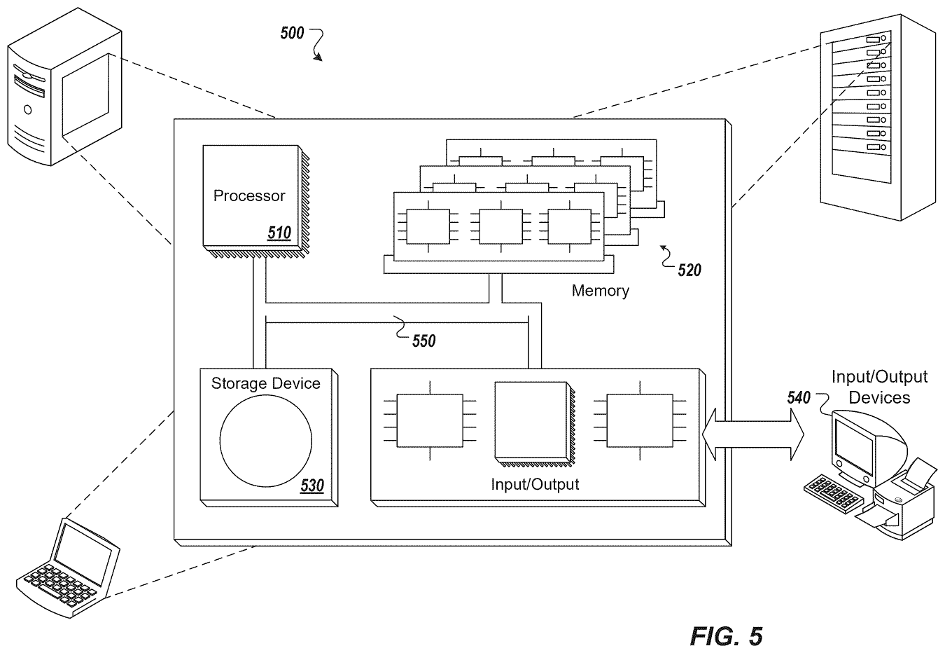

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for generating user-specific recommendations with reason text, the method being executed by one or more processors and comprising:
receiving a communication;
aggregating user data and event data, the user data representative of a user that as an addressee of the communication, the event data representative of an event described in the communication;
determining, from a graph neural network (GNN), a sub-GNN that is specific to the user, the GNN comprising a data structure that represents users of an enterprise and relationships between users, the sub-GNN representing a portion of the GNN;
providing an updated sub-GNN based on the event data;
generating a recommendation regarding the event using the updated sub-GNN, the recommendation being specific to the user;
providing reason text from a large language model (LLM) responsive to a prompt; and
transmitting a notification to the user, the notification comprising the recommendation and the reason text.

2. The method of claim 1, wherein providing an updated sub-GNN based on the event data comprises updating weight matrices of edges of the sub-GNN based on the event data.

3. The method of claim 2, wherein updating comprises each node of the sub-GNN executing computation and aggregation to update a respective weight matrix.

4. The method of claim 1, wherein the prompt is generated using a prompt template.

5. The method of claim 1, further comprising receiving feedback from the user regarding the event, at least a portion of the feedback being stored as an attribute in a node of the GNN, the node representing the user.

6. The method of claim 1, wherein the sub-GNN is a k-hop representation from a node of the user within the GNN.

7. The method of claim 1, wherein aggregating user data and event data is executed in response to determining that the communication describes the event.

8. A non-transitory computer-readable storage medium coupled to one or more processors and having instructions stored thereon which, when executed by the one or more processors, cause the one or more processors to perform operations for generating user-specific recommendations with reason text the operations comprising:
receiving a communication;
aggregating user data and event data, the user data representative of a user that as an addressee of the communication, the event data representative of an event described in the communication;
determining, from a graph neural network (GNN), a sub-GNN that is specific to the user, the GNN comprising a data structure that represents users of an enterprise and relationships between users, the sub-GNN representing a portion of the GNN;
providing an updated sub-GNN based on the event data;
generating a recommendation regarding the event using the updated sub-GNN, the recommendation being specific to the user;
providing reason text from a large language model (LLM) responsive to a prompt; and
transmitting a notification to the user, the notification comprising the recommendation and the reason text.

9. The non-transitory computer-readable storage medium of claim 8, wherein providing an updated sub-GNN based on the event data comprises updating weight matrices of edges of the sub-GNN based on the event data.

10. The non-transitory computer-readable storage medium of claim 9, wherein updating comprises each node of the sub-GNN executing computation and aggregation to update a respective weight matrix.

11. The non-transitory computer-readable storage medium of claim 8, wherein the prompt is generated using a prompt template.

12. The non-transitory computer-readable storage medium of claim 8, wherein operations further comprise receiving feedback from the user regarding the event, at least a portion of the feedback being stored as an attribute in a node of the GNN, the node representing the user.

13. The non-transitory computer-readable storage medium of claim 8, wherein the sub-GNN is a k-hop representation from a node of the user within the GNN.

14. The non-transitory computer-readable storage medium of claim 8, wherein aggregating user data and event data is executed in response to determining that the communication describes the event.

15. A system, comprising:
a computing device; and
a computer-readable storage device coupled to the computing device and having instructions stored thereon which, when executed by the computing device, cause the computing device to perform operations for generating user-specific recommendations with reason text, the operations comprising:
receiving a communication;
aggregating user data and event data, the user data representative of a user that as an addressee of the communication, the event data representative of an event described in the communication;
determining, from a graph neural network (GNN), a sub-GNN that is specific to the user, the GNN comprising a data structure that represents users of an enterprise and relationships between users, the sub-GNN representing a portion of the GNN;
providing an updated sub-GNN based on the event data;
generating a recommendation regarding the event using the updated sub-GNN, the recommendation being specific to the user;
providing reason text from a large language model (LLM) responsive to a prompt; and
transmitting a notification to the user, the notification comprising the recommendation and the reason text.

16. The system of claim 15, wherein providing an updated sub-GNN based on the event data comprises updating weight matrices of edges of the sub-GNN based on the event data.

17. The system of claim 16, wherein updating comprises each node of the sub-GNN executing computation and aggregation to update a respective weight matrix.

18. The system of claim 15, wherein the prompt is generated using a prompt template.

19. The system of claim 15, wherein operations further comprise receiving feedback from the user regarding the event, at least a portion of the feedback being stored as an attribute in a node of the GNN, the node representing the user.

20. The system of claim 15, wherein the sub-GNN is a k-hop representation from a node of the user within the GNN.
